(19) United States
(12) Patent Application Publication
(10) Pub. No.: US 2026/0361687 A1
(43) Pub. Date: Nov. 12, 2026

(54) Data Loss Prevention (DLP) for Japanese Addresses

(71) Applicant: Zscaler, Inc., San Jose, CA (US)

(72) Inventors: Zhifeng Zhang, Burnaby (CA); Vinh Tran, San Jose, CA (US); Arun Bhallamudi, San Jose (CA)

(73) Assignee: Zscaler, Inc., San Jose, CA (US)

(21) Appl. No.: 19/205,675

(22) Filed: May 12, 2025

(51) Int. Cl. H04L 9/40; H04L 43/08

(52) U.S. Cl. CPC H04L 63/0236; H04L 43/08

(57) ABSTRACT

Systems and methods for detecting Japanese addresses within network traffic via a cloud-based Data Loss Prevention (DLP) service include monitoring tenant traffic passing through the cloud-based DLP service to intercept payloads originating from one or more sources; detecting a first component of a Japanese address within the tenant traffic; responsive to detecting the first component, performing a pattern match to detect a second component of the Japanese address within the payload; and performing an action based on detecting a match to the second component of the Japanese address, wherein the action includes any of blocking transmission of the traffic, quarantining a payload for administrative review, generating an alert, or logging the detected match for audit purposes.

### FIELD OF THE DISCLOSURE

The present disclosure relates generally to computing. More particularly, the present disclosure relates to systems and methods for Data Loss Prevention (DLP) for Japanese Addresses.

### BACKGROUND OF THE DISCLOSURE

The increasing digitization of business operations and personal communications has resulted in a significant rise in the sharing and processing of sensitive information across cloud platforms, email systems, and collaboration tools. Organizations, especially multinational enterprises, are legally required to safeguard sensitive data, including Personally Identifiable Information (PII), in compliance with data protection laws such as Japan's Act on the Protection of Personal Information (APPI), the General Data Protection Regulation (GDPR), and other regional privacy regulations. Among the various types of PII, Japanese addresses carry significant sensitivity, and their protection is critical in preventing data leaks, unauthorized access, and non-compliance penalties. Detecting Japanese addresses within network traffic is uniquely challenging due to the linguistic and structural complexity of the addresses. Unlike Western addresses, Japanese addresses follow a hierarchical format and may appear in multiple character sets, including kanji, hiragana, katakana, and romaji. Furthermore, such data can exist within structured fields (e.g., databases) or unstructured formats (e.g., email text, spreadsheets, or plaintext traffic). Traditional pattern-matching tools, like those relying purely on regex-based approaches, struggle to effectively detect Japanese addresses without incurring significant computational costs, high false positives, or missed detections in large-scale deployments.

### BRIEF SUMMARY OF THE DISCLOSURE

The present disclosure relates to systems and methods for detecting Japanese addresses within network traffic via a cloud-based Data Loss Prevention (DLP) service. In various embodiments, the present disclosure includes a method having steps, a processing device configured to implement the steps, a cloud-based system configured to implement the steps, and as a non-transitory computer-readable medium storing instructions for programming one or more processors to execute the steps. The steps include monitoring tenant traffic passing through the cloud-based DLP service to intercept payloads originating from one or more sources; detecting a first component of a Japanese address within the tenant traffic; responsive to detecting the first component, performing a pattern match to detect a second component of the Japanese address within the payload; and performing an action based on detecting a match to the second component of the Japanese address, wherein the action includes any of blocking transmission of the traffic, quarantining a payload for administrative review, generating an alert, or logging the detected match for audit purposes.

The steps can further include wherein the first component of the Japanese address includes a combination of a prefecture and a city. The first component of the Japanese address can be detected using a hyperscan engine, the hyperscan engine performing high-speed scanning of tenant traffic against a precompiled database of potential prefecture and city combinations. The precompiled database of prefecture and city combinations can include standard combinations of Japanese prefectures and primary cities or their linguistic representations in kanji, hiragana, katakana, or romaji. The pattern match for the second component of the Japanese address can be performed using Perl Compatible Regular Expressions (PCRE) starting from the end of the detected first component. The steps can further include consolidating the first component and second component matches into a composite match trigger that captures the entire Japanese address from the beginning of the first component to the end of the second component. The steps can further include monitoring traffic dynamically in real time, such that matches are detected and actions are performed with minimal latency or disruption to tenant operations. The first component detection and second component detection can be stored as part of metadata records within the cloud-based DLP service for post-incident analysis. The steps can further include applying machine learning models to improve detection accuracy by analyzing context surrounding the detected first component and second component within payloads. The tenant traffic can include structured data, unstructured data, or multimedia files containing embedded Japanese address information.

### BRIEF DESCRIPTION OF THE DRAWINGS

The present disclosure is detailed through various drawings, where like components or steps are indicated by identical reference numbers for clarity and consistency.

FIG. 1 is a block diagram of a computing system 100 that may be used to implement various components described in this disclosure.

FIG. 2 is a diagram of traffic flow through a DLP system adapted to efficiently detect Japanese addresses.

FIG. 3 is a flowchart of a process for detecting Japanese addresses within network traffic via a cloud-based Data Loss Prevention (DLP) service.

### DETAILED DESCRIPTION OF THE DISCLOSURE

Again, the present disclosure relates to systems and methods for detecting Japanese addresses within network traffic via a cloud-based DLP service. The described invention introduces a hybrid detection system that leverages both hyperscan (a high-speed pattern-matching engine) and Perl Compatible Regular Expressions (PCRE) to accurately and efficiently detect Japanese addresses in real-time. By separating the address detection process into two distinct components, detecting the first part (prefecture and city) using hyperscan and validating the second part (street and building details) using PCRE, the invention significantly reduces computational overhead while maintaining precision. This approach is designed to enable organizations to proactively secure sensitive Japanese address data across a cloud-based DLP service, ensuring compliance with privacy laws and safeguarding customer information against data breaches or misuse.

### Example Computing System Architecture and Cloud Deployment

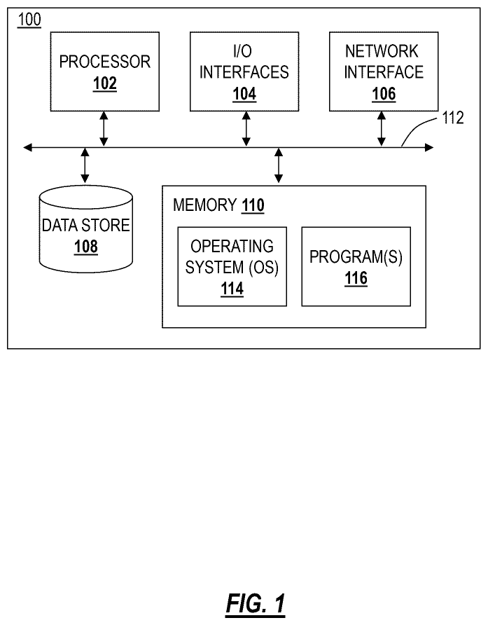

FIG. 1 is a block diagram of a computing system 100 that may be used to implement various components described in this disclosure. The computing system 100 can be implemented in many forms, including laptops, desktops, smartphones, tablets, physical servers, clusters of machines, virtual machines (VMs) running on hypervisors, or serverless computing frameworks. Regardless of the underlying infrastructure, the computing system 100 typically includes one or more processors 102, input/output (I/O) interfaces 104, a network interface 106, a data store 108, and memory 110. Note that FIG. 1 provides a simplified representation; in practice, the computing system 100 may include additional hardware and software elements. These components 102, 104, 106, 108, 110 are connected via a local interface 112, which can include various wired or wireless buses, high-speed interconnects, or switching fabrics. The local interface 112 may also include controllers, buffers, caches, drivers, repeaters, and receivers, along with addressing and control lines that facilitate efficient communication and resource sharing among components.

Each processor 102 is a hardware element—such as a central processing unit (CPU), multicore processor, system-on-chip (SoC), graphics processing unit (GPU), or a processing element within a larger compute cluster—designed to execute software instructions. These processors may be general-purpose or specialized, depending on performance, power efficiency, or workload needs. During operation, each processor 102 retrieves and executes instructions stored in memory 110, manages data exchanges with the data store 108, and oversees system 100 operations. In large-scale environments, multiple processors 102 may operate in parallel to handle elevated traffic and complex workloads.

The I/O interfaces 104 enable the computing system 100 to interact with external peripherals, allowing user input (e.g., via keyboards, touchscreens, or sensors) and system output (e.g., to displays or printers). Depending on the application, these I/O interfaces 104 may also support specialized devices used for maintenance, debugging, or other administrative functions. Meanwhile, the network interface 106 handles connectivity to external networks, which may include the Internet, private networks, or cloud environments. This network interface can use Ethernet, wireless local area networks (LANs), cellular connections, or virtualized cloud interfaces. By using secure transport protocols and encryption, data transmitted via the network interface 106 can remain protected, enabling the computing system 100 to participate safely in distributed or cloud-based deployments.

The data store 108 provides storage for both persistent and temporary data. It may include volatile memory (e.g., random access memory (RAM)) for high-speed operations and nonvolatile media (e.g., solid-state drives, hard disk drives, optical media) for long-term retention. In some deployments, the data store 108 may integrate with network-attached storage (NAS), storage area networks (SAN), or cloud-based storage solutions. These configurations can range from modest local setups to large-scale installations, potentially featuring global deduplication, compression, encryption at rest, and multi-site replication. The data store 108 can hold operational logs, configuration details, policy rules, program binaries, and cached computation results.

The memory 110 typically serves as the primary working memory for the processors 102. It may be composed of volatile elements (e.g., dynamic RAM (DRAM), double data rate (DDR), synchronous DRAM (SDRAM)) for fast access, as well as nonvolatile components such as flash memory or non-volatile RAM (NVRAM). The memory 110 can be distributed across nodes or servers to support the large-scale in-memory processing demanded by modern cloud services. Generally, the memory 110 stores the operating system (O/S) 114 and one or more programs 116. The O/S 114 handles core system tasks such as process scheduling, memory allocation, file management, and networking.

For Software-as-a-Service (SaaS) or other cloud-based components, the computing system 100 can be deployed in various ways: as a private cloud in a single organization's datacenter, a public cloud hosted by a third-party provider, or a hybrid cloud that combines both approaches for specific security, performance, or compliance considerations. Cloud computing abstracts physical hardware—servers, storage devices, and networks—into on-demand, scalable resources. This allows organizations to provision computing power, storage, and network bandwidth with minimal upfront costs, adjusting to fluctuating workloads seamlessly. According to the U.S. National Institute of Standards and Technology (NIST), cloud computing is “a model for enabling convenient, on-demand network access to a shared pool of configurable computing resources (e.g., networks, servers, storage, applications, and services) that can be rapidly provisioned and released with minimal management effort or service provider interaction.” Unlike traditional client-server environments, cloud computing typically delivers applications via a web interface, reducing the need for local installations and updates. Centralizing application hosting allows providers to uniformly release new features, apply security patches, and manage licensing. By using these SaaS models, end users can access software via browsers or lightweight clients, taking advantage of continuous improvements and frequent updates.

Various embodiments may utilize different forms of processing circuitry—general-purpose microprocessors, CPUs, digital signal processors (DSPs), network processors, GPUs, field programmable gate arrays (FPGAs), programmable logic devices (PLDs), or similar. This circuitry may be controlled by software, firmware, or a combination thereof, possibly alongside non-processor circuits to achieve the desired functionality. Specific tasks can also be handled by state machines or one or more application-specific integrated circuits (ASICs) that implement dedicated logic. In some cases, a hybrid approach may be adopted. Additionally, implementations can include a non-transitory computer-readable storage medium that stores computer-readable instructions. When executed by a device containing suitable processing circuitry, these instructions cause the system to perform the methods or algorithms described in this disclosure. Non-limiting examples of such storage media include hard disks, optical disks, magnetic devices, read-only memory (ROM) and its variants, flash memory, or other persistent/semi-persistent storage. Once stored, these instructions enable execution of the disclosed methods.

### Cloud-Based Data Loss Prevention (DLP)

The evolution of cloud computing, Software-as-a-Service (SaaS) applications, remote work, and global connectivity has redefined the way enterprises manage and protect their sensitive data. Traditional, appliance-based Data Loss Prevention (DLP) solutions that were once limited to on-premises environments have struggled to keep up with these modern demands. Businesses now operate in an interconnected, borderless digital world, where sensitive data flows freely between endpoints, cloud services, unmanaged personal devices, email platforms, and even collaboration tools. This shift has introduced significant risks around unintentional or malicious data leaks, regulatory compliance violations, and intellectual property theft. To address these growing challenges, cloud-based platforms, such as the cloud platform offered by Zscaler (the applicant and assignee of the present application) offer DLP service designed specifically to safeguard sensitive information with the scalability, ease of deployment, and flexibility that modern enterprise environments require. The cloud platform offered by Zscaler will be referred to as the platform, the cloud-based platform, the cloud platform, and the cloud-based system herein.

Unlike legacy DLP tools, the cloud-based platform's DLP service works seamlessly across distributed environments by routing user traffic through its globally distributed cloud infrastructure. It functions by intercepting, inspecting, and enforcing policies on data in real-time, regardless of where users are located or how they access corporate resources. Whether users are working in an office, at home, or on a public Wi-Fi network, all traffic, whether destined for SaaS applications, websites, private applications, or the internet, is routed through the platform's security service edge. This ensures that sensitive data is continuously monitored and protected without requiring additional appliances, Virtual Private Networks (VPNs), or on-premises hardware.

At the core of the DLP system is its cloud-native inspection engine, which analyzes data as it moves across the network to identify anything that matches predefined sensitive information criteria or custom organizational policies. Leveraging advanced techniques such as pattern matching, document fingerprinting, and Natural Language Processing (NLP), the inspection engine identifies Personally Identifiable Information (PII), payment card data, health records, intellectual property, confidential files, and more. For example, it can detect when a document containing Social Security numbers is being uploaded to an unsanctioned file-sharing service or when proprietary code is shared over collaboration tools. The inspection occurs in real-time so that protective actions, such as blocking, quarantining, or encrypting data, can be applied instantly based on organizational policies.

To support organizations in creating and customizing these policies, the platform offers a comprehensive data classification system. Administrators can leverage pre-built templates for compliance frameworks to ensure regulatory adherence, or they can define custom rules suited to their specific business needs. This classification system allows organizations to label data according to its sensitivity and enforce highly granular controls. For example, a company's finance department might label spreadsheets containing credit card transactions as “confidential,” restricting their transfer to external domains or limiting them to encrypted methods of communication.

To secure data moving to and from cloud applications, the platform integrates with its Cloud Access Security Broker (CASB) component. This module provides deep traffic inspection and visibility across SaaS platforms like Google Workspace, Microsoft 365, Salesforce, and Dropbox. Whether analyzing email attachments sent via Outlook or files uploaded to Google Drive, the CASB ensures that data sharing follows organizational policies, and unauthorized access is flagged or blocked. For instance, an employee inadvertently attempting to share an internal report marked “confidential” to a personal Gmail account would trigger an alert, blocking the action and notifying administrators.

The DLP service's granular policy engine acts as the decision-maker, applying contextual rules that consider not only the data itself but also the broader context in which the data is being accessed. Policies can be tailored to allow, block, or restrict data transfers based on factors such as user role, geographic location, application in use, or device security posture. For example, contractors accessing company data from unmanaged devices might encounter stricter restrictions compared to full-time employees using company-issued laptops. This context-aware approach ensures that accidental violations are minimized while empowering trusted employees to work efficiently within their roles.

Another cornerstone of the platform's DLP service is its context-aware inspection capability, which enhances precision by analyzing the broader scenario in which a data transfer is occurring. It looks beyond just the content itself, factoring in elements like user identity, device security posture, time of access, and the data's intended destination. This capability provides administrators with a deeper understanding of potential risks while reducing false positives. For example, the same file transfer to a partner organization may be permitted when initiated from an office location using secured encrypted channels but blocked when attempted from an unmanaged device on public Wi-Fi.

Additionally, all traffic and inspection decisions occur through the platform's globally connected Security Service Edge (SSE) architecture, ensuring seamless performance for users across the globe. By routing traffic to geographically distributed inspection nodes, the platform reduces latency and delivers fast, uninterrupted connectivity even as data is inspected, classified, and monitored in real time. This eliminates the need for hardware appliances or virtualized DLP instances that traditionally caused bottlenecks or relied on clunky routing mechanisms like VPNs.

To ensure organizations can act on potential risks and incidents promptly, the DLP service includes a data quarantine and incident management system. If sensitive data is flagged as part of a policy violation, such as an employee attempting to upload confidential research documents to a personal account, administrators can quarantine the transfer and initiate investigations. The system provides detailed logging, incident timelines, and risk scoring to help teams understand and resolve issues quickly. By connecting these capabilities with broader monitoring tools of the cloud platform such as Security Information and Event Management (SIEM) solutions, enterprises gain a comprehensive view of their data risks and incident trends.

This cloud-based DLP service offers transformative benefits for businesses over legacy, hardware-based approaches to data protection. Its comprehensive data visibility ensures organizations can monitor the flow of information not only within corporate environments but also across SaaS platforms, hybrid systems, and external destinations. The cloud-native architecture simplifies management by allowing DLP policies to be configured, enforced, and monitored through a single dashboard, eliminating the need for costly hardware upgrades and manual maintenance. Scalability is built into the design, enabling enterprises to protect thousands, or even millions, of users without the logistical and operational headaches associated with deploying on-prem micro-appliances. Moreover, the platform delivers true real-time protection, applying data protection policies without impacting user productivity, a critical need for today's fast-paced, remote-enabled workforce.

Perhaps most importantly, the DLP service enables businesses to meet the demands of modern regulatory compliance frameworks, with prebuilt profiles for General Data Protection Regulation (GDPR), Health Insurance Portability and Accountability Act (HIPAA), Payment Card Industry Data Security Standard (PCI DSS), and more, ensuring businesses are always audit-ready. By enforcing policies across an increasingly mobile and distributed workforce, organizations can confidently enable remote work and cloud adoption, mitigating risks such as insider threats, external attackers, and inadvertent compliance violations. The overall result is an agile, scalable, and proactive approach to data protection that matches the dynamic nature of today's enterprise environments while simplifying operations for Information Technology (IT) teams. In a world where sensitive data is constantly in motion, the cloud-based platform's DLP service is an essential tool for securing the modern workplace.

### DLP via Hyperscan

A hyperscan database is a high-performance pattern-matching engine designed for rapidly scanning and identifying specific patterns, keywords, or data signatures within large volumes of data at exceptional speeds. It is frequently employed in a variety of security solutions, including DLP, Intrusion Detection Systems (IDS), antivirus programs, and other content-inspection tools that require robust, real-time Deep Packet Inspection (DPI). Hyperscan is highly effective at analyzing data streams for predefined patterns or expressions by leveraging advanced technologies like regular expressions and finite automata. Its ability to perform simultaneous, real-time searches ensures that it can handle the complex and large-scale data processing demands of modern enterprise environments.

Within the context of the cloud-based DLP described herein, the hyperscan database serves as a foundational component of the platform's inspection engine, enabling the detection of sensitive information such as PII, payment card data, intellectual property, healthcare-related data, etc. Its remarkable performance and low-latency operation make it an essential tool for the cloud-based DLP service, which must continually protect sensitive information in distributed environments without impacting user productivity. By combining hyperscan's rapid pattern-matching capabilities with other advanced data classification and policy enforcement tools, the present systems can reliably safeguard sensitive information, whether it is in motion (e.g., web traffic, emails), at rest (e.g., cloud storage), or in use (e.g., document collaboration).

The DLP service processes enormous amounts of data in real time, inspecting information transmitted over web traffic, emails, file uploads, and various cloud applications. This is where the hyperscan database plays a crucial role as part of the DLP service's content inspection engine. It allows for the real-time scanning and analysis of data streams against predefined rules and patterns to identify sensitive information with high accuracy and efficiency. For instance, hyperscan offers pattern recognition, utilizing a library of predefined rules, such as regular expressions for credit card numbers, Social Security numbers, or specific keywords such as “confidential” or “internal use only.” Regardless of the size of the dataset being analyzed, the utilization of hyperscan can quickly evaluate whether a pattern matches sensitive data, enabling immediate action based on the organization's policies.

In addition to pattern recognition, the hyperscan database contributes to the real-time scanning of traffic. The DLP system uses hyperscan to inspect data as it flows through different channels, such as files being uploaded via websites, outgoing email attachments, or data shared on SaaS platforms like Google Drive or Dropbox. Hyperscan compares this information against sensitive data patterns stored in its database to ensure compliance with data governance policies. Its unparalleled speed ensures that sensitive inspections are conducted in real-time without causing noticeable delays for end users, a critical factor for maintaining a seamless user experience in high-throughput environments. Furthermore, hyperscan is optimized for multi-pattern matching, enabling it to inspect files or data streams for hundreds or even thousands of patterns simultaneously. For example, a single email or document could contain multiple sensitive elements, such as PII and intellectual property, with hyperscan analyzing the content efficiently, whether the information resides within structured formats (e.g., online forms) or unstructured environments (e.g., free-text files or emails).

The hyperscan database also offers significant flexibility through custom rule creation, allowing organizations to define patterns that are specific to their business or industry requirements. For example, a pharmaceutical company aiming to monitor the transfer of proprietary formulas or research data can use custom rules within hyperscan. Similarly, financial institutions might deploy patterns tailored to detect account numbers, investment deal terms, or other specialized data formats. By supporting such custom patterns, hyperscan adapts to the unique needs of diverse industries, enhancing the overall effectiveness of the DLP solution. Additionally, hyperscan integrates with intelligent content filtering capabilities, pairing its pattern-matching results with broader context-aware inspections in the DLP system. This ensures that flagged incidents are evaluated within their full context, taking into account user roles, device types, and the destination of the data. For example, if hyperscan detects a spreadsheet containing customer credit card data being emailed externally, the DLP system can block the transfer or quarantine the document based on predefined policies.

Performance optimization is another critical strength of hyperscan, as it enables DLP solutions in cloud-first environments to handle ever-growing enterprise traffic without bottlenecks or processing delays. Built with optimized algorithms for searching complex regular expressions efficiently, hyperscan allows the DLP service to scale effortlessly, even as the volume of data and the number of sensitive patterns being monitored increases. This scalability makes hyperscan highly valuable in large organizational environments where high-throughput inspections across web applications and cloud traffic are critical to maintaining data security. Its low-latency performance is particularly advantageous for modern workflows requiring the protection of real-time data transmissions, such as during live uploads to storage platforms or the use of online collaboration tools.

The integration of hyperscan into the DLP service introduces several notable benefits. For one, hyperscan delivers speed and efficiency by enabling rapid pattern matching across vast datasets without introducing delays, making it ideal for deployment in high-traffic and latency-sensitive environments. It also ensures high accuracy and precision by employing advanced pattern-analysis techniques to minimize false positives (incorrectly flagging valid activities) and false negatives (failing to detect sensitive data). Additionally, hyperscan offers unmatched scalability, easily handling increases in traffic volume, the complexity of rules, or the size of user bases without performance degradation. Its ability to support customization for specific needs ensures organizations can tailor its functionality to meet unique industry or compliance requirements, such as identifying intellectual property, trade secrets, or highly specialized data signatures.

### DLP via Perl Compatible Regular Expressions (PCRE)

PCRE (Perl Compatible Regular Expressions) is an open-source library known for its powerful and flexible pattern-matching capabilities, which are based on regular expressions. Regular expressions are sequences of characters that define search patterns, used to identify specific strings or text within data sets. PCRE is modeled after the syntax and semantics of the Perl programming language's pattern-matching engine, which is recognized for its robustness and versatility. This library supports advanced features, including lookahead and lookbehind assertions, capturing groups, lazy matching, and more. Its extensive functionality has made it a popular choice for applications that require complex pattern-matching solutions.

Due to its high performance and cross-platform compatibility, PCRE has become a fundamental tool in many fields, particularly in cybersecurity and data inspection tasks. Its ability to create precise and intricate search patterns makes it well-suited for analyzing large amounts of data, including unstructured information. In the context of DLP, PCRE is critical for detecting sensitive data, monitoring adherence to compliance policies, and ensuring sensitive information is safeguarded during its transmission, storage, or usage across systems.

When integrated into the DLP service, PCRE becomes essential for pattern-matching and content-inspection processes that underpin the detection of sensitive information. Again, the DLP service protects data by monitoring, classifying, and securing sensitive content. In various embodiments, the DLP service leverages PCRE to execute advanced search and matching to scan data streams and pinpoint sensitive patterns. This is particularly important for enterprises that must comply with regulatory standards or protect proprietary data from unauthorized access or sharing.

One of PCRE's most important contributions to DLP is its ability to provide customizable and precise pattern matching. DLP solutions often need to identify highly specific data patterns based on organizational requirements or legal regulations, such as credit card numbers, Social Security numbers, passwords, or medical records. With PCRE, administrators can define regular expressions for these patterns with pinpoint accuracy. For example, a pattern for detecting credit card numbers might account for 16-digit sequences while adhering to Luhn's checksum validation algorithm, while a Social Security number pattern might look for a specific 3-2-4 digit format (e.g., \d{3}-\d{2}-\d{4}). The flexibility of PCRE enables organizations to tailor their DLP policies to unique industries, geographic regions, or business requirements, ensuring effective protection without relying on static or generic rules.

PCRE also facilitates the inspection of both structured and unstructured data, which is critical in diverse enterprise environments. Structured data, such as database records or standardized forms, follows predictable formats, making pattern matching straightforward. However, unstructured data, like free-text documents, emails, or chat logs, requires sophisticated patterns to identify sensitive content embedded in varying contexts. PCRE enables the DLP service to process both types effectively. For example, it can scan structured email fields to recognize credit card numbers submitted in a form (e.g., “Card Number: 4111-1111-1111-1111”) or detect sensitive customer data, such as a private address or phone number, shared in an email's unstructured body text. By extending its capabilities across these scenarios, PCRE ensures comprehensive protection for diverse data types.

Another crucial function of PCRE in DLP is the detection of compliance violations. Regulatory frameworks like GDPR, HIPAA, California Consumer Privacy Act (CCPA), and PCI DSS require organizations to implement stringent data protection measures. The DLP service uses PCRE to identify patterns linked to compliance violations, such as unencrypted sharing of financial records via email or confidential intellectual property uploads to unsanctioned cloud storage solutions. With its advanced pattern-matching techniques, PCRE minimizes false positives (accidental flagging of non-sensitive data) and false negatives (failure to detect sensitive data), ensuring more accurate enforcement of compliance policies.

Additionally, PCRE enables real-time inspection of data in motion. These systems must inspect data as it moves across networks, whether it's being uploaded to cloud services, sent via email, or shared through chat applications. With PCRE, the DLP service can detect sensitive patterns within data streams instantly. For example, if an employee attempts to attach a spreadsheet containing PII (e.g., names, addresses, or Social Security numbers) to an outgoing email, PCRE will help identify these sensitive patterns based on predefined rules, allowing the platform to block the transfer or notify administrators. Similarly, PCRE aids in scanning files uploaded to platforms such as Google Drive or Dropbox, ensuring compliance with data governance policies in real time.

PCRE's adaptability also extends to encryption and obfuscation detection, where it identifies sensitive data that has been altered to avoid detection. For example, a user might obfuscate a Social Security number by writing it as “123_45_6789” or embedding it within larger blocks of text. With PCRE, the DLP service can account for such variations using flexible patterns, improving detection accuracy. Similarly, when analyzing partially restored or decrypted content, PCRE can refine its search patterns to identify reconstructed sensitive data during or after decryption processes.

PCRE's flexibility supports industry-specific use cases, making it invaluable in domains with unique data protection requirements. For instance, healthcare providers can configure PCRE patterns to recognize identifiers related to patient records, medical diagnostic codes, or health insurance data. Financial institutions can use PCRE to monitor sensitive information such as investment account numbers, wire transfer details, or proprietary trading algorithms. The library's robust syntax ensures these industry-specific needs are addressed with precision, reducing disruptions to legitimate workflows while maintaining robust data protection.

The integration of PCRE into the DLP service delivers significant benefits that enhance enterprise data security. Its flexibility and precision allow for highly specific regular expressions to detect a wide variety of sensitive data types, minimizing the likelihood of errors. PCRE is also optimized for efficiency in real-time scenarios, enabling rapid execution of complex pattern matches without introducing latency, even when inspecting large data volumes. It is scalable, capable of handling the growing data needs of modern enterprises, and adaptable for crafting regular expressions tailored to unique organizational or compliance requirements. Moreover, its support for complex and dynamic patterns, such as those involving lookahead and lookbehind assertions, makes it well-suited for detecting nuanced or obfuscated data that standard pattern-matching techniques cannot address.

### DLP for Japanese Addresses

Performing DLP on Japanese addresses presents significant challenges due to the complexity and variability of their structure, the inherent ambiguity in linguistic representation, and the computational intensity required for pattern matching. Japanese addresses follow a reverse hierarchical structure, starting with the largest geographic unit (such as a prefecture) and narrowing down to smaller areas like wards, districts, and individual buildings. This structure, combined with numerous components, such as “Chome” areas, numeric block identifiers, and additional geographic details, results in a wide range of possible combinations and permutations that the DLP service must account for. Additionally, Japanese addresses lack uniform formatting, which leads to variations in delimiters (e.g., hyphens, spaces, or no separators) and the order of address components. The absence of clear markers or keywords, which are commonly found in Western addresses (like “Street” or “Avenue”), makes detecting Japanese addresses far more ambiguous and resource-intensive.

The complexity is further exacerbated by the use of multiple character sets in Japanese: kanji (logographic characters), hiragana, katakana, and Romanized representations (romaji). The same address can appear in any of these formats, or even a mix of them, introducing an extensive search space. For instance, the address [symbol] [symbol] 1 [symbol] 1-1 (Tokyo, Shinjuku Ward, Nishi-Shinjuku, 1-Chome, 1-1) could be written in kanji, hiragana ( [symbol] [symbol] [symbol] ), or romaji (TOKYO-TO SHINJUKU-KU NISHI-SHINJUKU 1-1-1). These variations require DLP systems to use highly complex pattern-matching and regular expressions (regex) capable of accounting for linguistic diversity. Furthermore, kanji characters may have alternative readings or meanings, increasing the likelihood of false positives and missed detections when these sequences appear in unrelated contexts. The need for context-aware analysis, in which surrounding data is examined to distinguish geographic information from unrelated kanji or numeric strings, further strains computational resources.

Pattern matching against Japanese addresses is extraordinarily resource-intensive because of variable-length patterns, inconsistent formatting, and frequent use of regional conventions, as well as exceptions to those conventions. While structured data, such as database fields, might lend itself more readily to detection, unstructured data, such as email text, chat logs, or document content, compounds the difficulty. Japanese addresses often appear in free text or unconventional formats, requiring sophisticated regexes to identify them amidst a noisy dataset. For example, delimiters like spaces or slashes may be included inconsistently, or numeric strings might represent unrelated data entirely if not analyzed correctly. This ambiguity means that DLP systems often generate a high volume of false positives, such as when numeric patterns or random kanji sequences simulate parts of an address (e.g., “123-45-6789” resembling a postal code). Conversely, formatting deviations or missing components, like omitting “Chome” or using abbreviations, can result in false negatives, where valid addresses go undetected. Balancing between precision and accuracy requires computationally expensive contextual and post-matching validations, such as cross-referencing payloads with verified geographic data or integrating machine learning models, both of which generate additional system load.

Real-time detection, such as inspecting traffic payloads across network uploads, email attachments, or cloud storage, introduces further performance challenges. The need to scan for Japanese addresses across large volumes of high-throughput traffic while avoiding latency or bottlenecks demands massive amounts of processing power. Each piece of content must be evaluated against expansive sets of regex patterns designed to capture address variations across kanji, romaji, and other character sets. These regex evaluations are inherently computationally expensive, especially when accounting for potential obfuscation or non-standardized formats (e.g., addresses written differently, such as “1-1-1” versus “1 1 1” or simply “111”). Furthermore, individuals may attempt to intentionally obfuscate sensitive data by introducing irregular formats, such as masking Social Security equivalents (e.g., using “123_45_6789”) or embedding address details within surrounding text. DLP systems relying solely on regex often struggle to adequately detect these intentional deviations without significant performance penalties, as each variation requires additional rules and algorithms to ensure comprehensive scanning.

The resource demands are compounded by the need for scalability and accuracy in enterprise-scale DLP deployments, where mismatches in Japanese addresses could lead to major data breaches or compliance violations. Unlike simpler data types, such as credit card numbers (with highly consistent patterns), Japanese addresses require extraordinarily complex regexes that exponentially increase the processing time for each inspection. Furthermore, false positives or false negatives from ambiguous matches often result in further validation steps, such as manual reviews or additional parsing by machine learning algorithms, which in turn increase the computational burden on DLP platforms. This problem becomes particularly challenging in real-time data inspection, such as monitoring live web traffic, where delays caused by intensive regex analysis can disrupt normal operations.

In summary, detecting Japanese addresses within DLP systems is an extraordinarily resource-heavy task due to the structural complexity, linguistic variability, and contextual dependencies inherent to Japanese geographic information. The requirement to effectively analyze multiple character sets, irregular delimiters, varying formats, and ambiguous contexts forces DLP platforms to devote significant computational power to pattern-matching tasks. Organizations must adopt highly optimized regex engines, integrate advanced dictionaries or cross-referencing tools, and deploy specialized AI or machine learning systems to scale these protections effectively while minimizing the operational cost of detecting Japanese addresses in traffic and payloads. These efforts, while effective, demonstrate the immense challenges of performing DLP on Japanese addresses in a way that is both accurate and efficient.

To address the significant challenges and computational demands associated with detecting Japanese addresses in a DLP service, the present invention introduces systems and methods for detecting Japanese addresses via a DLP service. This solution is specifically designed to overcome the difficulties posed by the structural complexity, linguistic variability, and contextual nuances of Japanese addresses while minimizing the resource intensiveness traditionally required for pattern matching. By rethinking the approach to address detection and leveraging optimized systems and methods, this invention aims to deliver both accuracy and scalability in DLP platforms tasked with inspecting sensitive information in real-time or at rest.

This invention introduces advanced methodologies for the inspection and recognition of Japanese address patterns, breaking away from the reliance on purely regex-based pattern matching, which is computationally expensive and prone to inefficiencies when handling the diverse formats of Japanese addresses. Instead, the present systems and methods employ a hybrid approach that combines dictionary-based matching, linguistic parsing, and context-aware analysis. In various embodiments, the system builds an extensive database of address components, such as all known prefectures, wards, subdistricts, and common geographic indicators in Japan. Using this curated data, it can internally map address components rather than trying to match long, complex patterns linearly. This process reduces the computational overhead while improving accuracy, as it leverages deterministic matching to validate whether a sequence of characters corresponds to a valid Japanese address or simply a random string resembling one.

The use of precompiled patterns and custom tokenization further enhances performance. Rather than relying on expansive and dynamic regular expressions that must evaluate every character or sequence, this system tokenizes data inputs into meaningful segments (e.g., kanji delimiters, numeric blocks, or suffixes like “ [symbol] ” for Chome) for rapid pre-validation. By identifying these segments and only performing deeper inspections when preliminary matches occur, the system narrows the amount of data requiring resource-intensive analysis. Additionally, the invention incorporates character normalization techniques to handle the variability in representations, such as alternating between kanji, hiragana, katakana, or romaji, which have traditionally required numerous different regex patterns for detection. By automatically normalizing input data formats and mapping corresponding address elements across character sets, it significantly simplifies the detection process without sacrificing coverage.

Another core feature of this invention is its integration of contextual heuristics and machine learning models. Rather than relying purely on static rules, the system uses linguistic models trained on Japanese address conventions to evaluate ambiguity and determine whether a detected sequence is genuinely an address. For example, the system can differentiate between numeric strings used in geographic identifiers and those used for unrelated contexts, such as product IDs or financial records, by analyzing the surrounding data for keywords, patterns, or linguistic markers. This reduces false positives and ensures that computational resources are focused on meaningful detections. Machine learning models also play an essential role in learning variants of common address formats, gradually improving detection accuracy over time by identifying frequently encountered anomalies or obfuscated patterns.

Importantly, this invention solves the issue of real-time performance for high-throughput environments. By leveraging a distributed processing architecture and intelligent buffering, the system can inspect address data in motion, such as in network traffic, email attachments, or cloud uploads, without introducing bottlenecks or latency. Its use of optimized algorithms and parallelized workflows ensures that even large-scale deployments, such as global enterprises requiring comprehensive address monitoring, can integrate Japanese address inspection without overwhelming the DLP service's processing capacity. Furthermore, the modularity of this system allows it to be easily updated with new address patterns, regional data, or character set mappings, keeping it effective as data formats or geographic conventions evolve.

To efficiently detect Japanese addresses within data streams while minimizing the computational resources traditionally required for pattern matching, various embodiments of the present systems and methods employ a hybrid approach that incorporates both a hyperscan database and compilation using PCRE. This two-stage detection method leverages the strengths of both technologies, ensuring high-performance execution while maintaining precision. By separating Japanese addresses into distinct components, the system simplifies the matching process and reduces the complexity of detecting full addresses across diverse payloads.

The hybrid approach begins by logically splitting Japanese addresses into two main components. The first component includes the prefecture and a primary geographic marker referred to herein as “city 1” (typically the municipal city or town name within the prefecture). The second component contains the remaining details, such as “city 2” (subdivision or smaller locality within the city), street number, building number, unit number, and any other residual identifying information. For example, in the Japanese address “ [symbol] [symbol] 1 [symbol] 1-1”, the first component would be “ [symbol] ” (Tokyo Prefecture+Shinjuku City), while the second component would be “ [symbol] 1 [symbol] 1-1” (Nishi-Shinjuku, 1-Chome, 1-1). This segmentation reduces the scope of pattern matching in real-time, streamlining the detection process.

To enable optimized detection, the system compiles all possible combinations of (prefecture+city 1) into a Hyperscan database. This database is specifically tailored to handle large-scale pattern matching quickly and efficiently, leveraging hyperscan's capability to perform simultaneous searches across precompiled patterns with minimal computational overhead. By focusing solely on the first component of the address, the hyperscan database reduces the number of patterns that need to be matched within the initial stage of analysis, enabling rapid identification of potential Japanese addresses in payloads.

Implementing the matching process involves two steps, leveraging the hyperscan database for the first stage and PCRE for the second. In the first step, the system uses the hyperscan engine to scan payloads for (prefecture+city 1) combinations. hyperscan's high-speed scanning identifies matches for the first component of Japanese addresses within network traffic, documents, or any textual payload. When a match is detected, the hyperscan engine triggers a callback function that initiates the second step of the method. In this second step, the system uses the PCRE engine to match the remaining portion of the address (the second component), which includes city 2, street number, building number, unit number, and any additional details.

The PCRE matching process begins at the end of the first component that was matched by the hyperscan engine. Specifically, the system analyzes a portion of the payload that starts after the first match and continues for up to 60 bytes (or any other predefined length) or until the end of the payload, whichever comes first. This restriction ensures that only contextually relevant content is analyzed without unnecessarily expanding the scope of inspection, which minimizes resource consumption. The PCRE engine evaluates whether the second component matches predefined patterns for Japanese address formatting, such as numeric strings for street numbers, building identifiers, and unit identifiers, as well as specific tokens like “ [symbol] ” (Chome).

A match is only reported and triggers the DLP service if both steps succeed, i.e., the hyperscan engine detects the first component (prefecture+city 1), and the PCRE engine confirms the second component matches the address format in the designated portion of the payload. The system consolidates these matches to create a trigger that encompasses the entire address, starting from the beginning of the first component detected by the hyperscan engine and ending at the conclusion of the second component validated by the PCRE engine. For example, in the address “ [symbol] [symbol] 1 [symbol] 1-1”, the trigger would begin at “ [symbol] ” (prefecture) and extend through “ [symbol] 1 [symbol] 1-1” (remaining details). This comprehensive trigger ensures that the full Japanese address is captured and flagged accurately.

This hybrid approach effectively balances performance and precision by dividing the detection process into manageable stages. Hyperscan, with its high-speed processing capabilities, efficiently filters payloads based on the first component of Japanese addresses, significantly narrowing the scope of data requiring deeper inspection. PCRE, which excels at complex pattern matching, is then utilized to validate the second component in a more resource-intensive second step. By offloading the initial detection task to hyperscan, the system avoids the computationally expensive scenario of applying regex patterns across entire payloads indiscriminately. The stepwise nature of the method also reduces false positives and ensures that only complete and valid addresses, spanning both components, are flagged as matches.

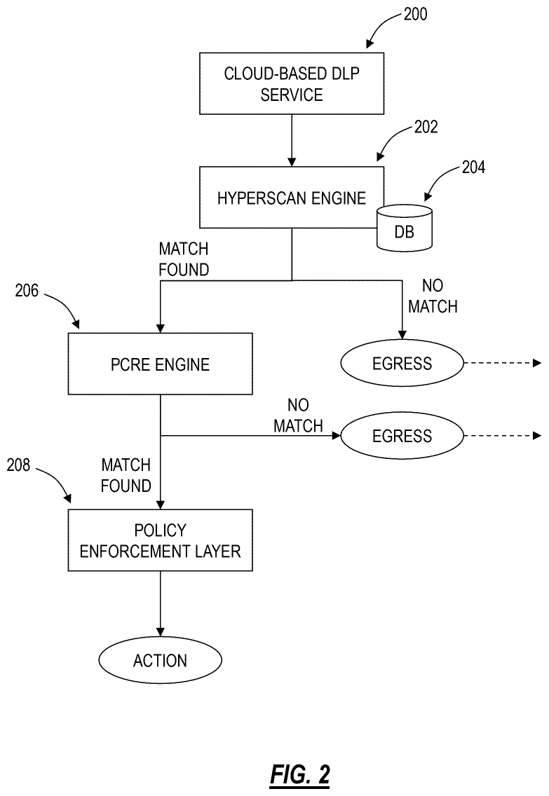

FIG. 2 is a diagram of traffic flow through a DLP system 200 adapted to efficiently detect Japanese addresses. The architecture for detecting Japanese addresses in the cloud-based DLP system 200 is built around several critical components that work cohesively to ensure sensitive information is identified, validated, and managed efficiently. At the core of the system is the cloud-based DLP infrastructure, which serves as the overarching framework where the solution operates. This infrastructure is responsible for intercepting traffic from various channels, routing it through the inspection layers, analyzing its content, and enforcing policies. It also facilitates communication and integration with the hyperscan engine 202 and PCRE engine 206 during the detection process to achieve seamless analysis of payloads.

Incoming traffic flows through a traffic ingress module of the cloud-based DLP service 200, which acts as the entry point for data sent from endpoints, networks, email systems, file uploads, collaboration tools, or cloud applications. Examples of such traffic include Hypertext Transfer Protocol Secure (HTTPS) uploads, email attachments, web traffic, and API calls. This raw payload data is then routed through the detection pipeline for processing. The hyperscan engine 202 and database 204 is positioned as the initial filtering engine within this pipeline, leveraging its precompiled database 204 of all potential (prefecture+city 1) combinations in Japanese addresses (e.g., “ [symbol] ”). The hyperscan engine 202 performs high-speed, real-time scanning of incoming payloads to detect matches with the first component of a Japanese address. By efficiently filtering payloads based on prefecture-city combinations, it reduces the computational burden on downstream systems.

Upon flagging a match during the first step, the hyperscan engine 202 triggers a callback function that sends the flagged payload to the PCRE engine 206, which acts as the secondary validation layer. The PCRE engine 206 performs detailed pattern matching for the second component of a Japanese address, including specific details such as sub-areas, street numbers, building numbers, unit identifiers, and other localized details. It analyzes the data starting from the end of the match detected by hyperscan and scans up to 60 bytes or until the end of the payload, whichever comes first. The PCRE engine 206 utilizes advanced regular expressions to identify elements like numerical street numbers, building/unit numbers, and Chome markers. If both the first and second components match successfully, the system validates the complete address as sensitive data.

Once both components of a Japanese address are successfully detected, the system consolidates the match into a composite trigger. This trigger captures the entire address, starting from the beginning of the first match and ending at the last detail in the second match. The consolidated trigger is then sent to the policy enforcement layer 208, which determines how to handle the detected data based on predefined rules. Actions may include blocking the transfer, preventing further transmission or upload of the flagged payload; quarantining the content, which isolates the flagged data for inspection or review by administrators or compliance teams; or alerting and auditing, where the system generates a security or compliance notification and logs the context, origin, and content of the flagged address for investigative purposes.

Finally, if no match is found during hyperscan processing or if the payload fails PCRE validation, the data is deemed compliant and exits the system seamlessly through the traffic egress layer. This module ensures that benign or authorized data flows forward to its intended destination without disruption. By employing a hybrid approach that combines the speed of Hyperscan for filtering with the precision of PCRE for validation, this architecture provides an efficient and scalable solution for detecting sensitive Japanese addresses within large-scale traffic streams while upholding performance and accuracy.

In summary, the present systems introduce an innovative hybrid approach that combines the speed and efficiency of hyperscan with the precision of PCRE to detect Japanese addresses in network traffic and payloads. By separating addresses into two logical components and designing a two-step matching method, this system reduces computational resource demands while maintaining accuracy. Hyperscan focuses on the rapid identification of (prefecture+city 1), while PCRE validates the second component, ensuring only full matches are reported. This design is scalable and highly optimized, making it suitable for enterprise-grade DLP solutions tasked with analyzing sensitive Japanese address information in real-time and at scale.

### Use Case

A multinational corporation that operates across several regions, including Japan, faces the challenge of protecting sensitive customer data, such as PII, including Japanese residential addresses. With strict regulatory frameworks like Japan's Act on the Protection of Personal Information (APPI) and global laws such as GDPR, the company must ensure that Japanese address data is safeguarded across its communication and storage systems. However, with the rise of remote work, collaboration platforms, cloud applications, and high employee mobility, there is an increased risk of accidental or malicious data leaks. Employees frequently upload shipping records, share customer address data via emails or collaboration tools, or store unencrypted files containing sensitive information in unsanctioned cloud storage services. The complexity of Japanese address detection, given its hierarchical structure, linguistic variability, and diverse formats, further compounds the problem, making it difficult for traditional DLP solutions to detect or block such data efficiently without high resource demands.

To detect Japanese addresses more effectively, the system breaks them into two logical components. The first component contains the prefecture and a primary geographic unit known as “city 1” (e.g., Tokyo Prefecture+Shibuya City in the address “ [symbol] [symbol] 1 [symbol] 23-5”). The second component includes detailed local identifiers such as “city 2” (subdivisions like neighborhoods), street numbers, building numbers, unit numbers, and any remaining identifying information (e.g., “ [symbol] 1 [symbol] 23-5,” or Ninnan 1-Chome, 23-5). This segmentation allows the detection process to be carried out in two steps. In the first step, all possible combinations of (prefecture+city 1) are precompiled into a hyperscan database, which efficiently scans over network traffic, payloads, and documents, identifying matches for the first component. Hyperscan, optimized for high-speed pattern matching, acts as a rapid prefilter, reducing the volume of data requiring deeper analysis and ensuring minimal latency even in high-throughput environments. When hyperscan identifies a potential match, a callback function triggers the second step, where the remaining part of the address, the second component, is validated using PCRE. The PCRE engine scans the text starting from the end of the hyperscan-identified first match and evaluates up to 60 bytes (or until the end of the payload, whichever comes first) for patterns resembling Japanese address formats, such as Chome identifiers, numeric street numbers, and unit-level specifications. If both components match successfully, the system confirms the detection of a full Japanese address and generates a trigger, consolidating the detected address components into a single reportable entity.

The present cloud-based system allows the company/tenant to implement the present solution across key communication and data-sharing channels, such as email servers, collaboration platforms like Microsoft Teams or Slack, cloud storage services like Google Drive, and file upload portals. Through real-time monitoring, the system ensures that any attempt to exfiltrate customer addresses, whether through emails, downloads, or uploads, can be detected and blocked based on DLP policies. For example, if a file containing sensitive information is uploaded to an unsanctioned cloud platform or shared directly with external recipients, the system detects and quarantines the address data, triggering administrative alerts or terminating the transmission depending on preconfigured policies. This capability is particularly beneficial for both intentional and accidental violations, as it acts proactively to ensure compliance and data integrity without disrupting legitimate business operations.

Ultimately, the hybrid detection approach introduced by the present systems and methods solves the longstanding challenges of ensuring compliance with global regulations while allowing organizations to streamline data security efforts. By efficiently detecting Japanese addresses with high accuracy and scalability, the system reduces the computational burden associated with exclusively regex-based approaches and achieves real-time protection against unauthorized data exfiltration. Its modularity and scalability also make it suitable for high-volume environments and global enterprises, ensuring sensitive Japanese address data remains protected across various channels of communication and storage. This use case demonstrates the effectiveness of the invention in balancing organizational security demands with operational efficiency, safeguarding customer PII while maintaining compliance in increasingly complex digital environments.

### Process for Performing DLP on Japanese Addresses

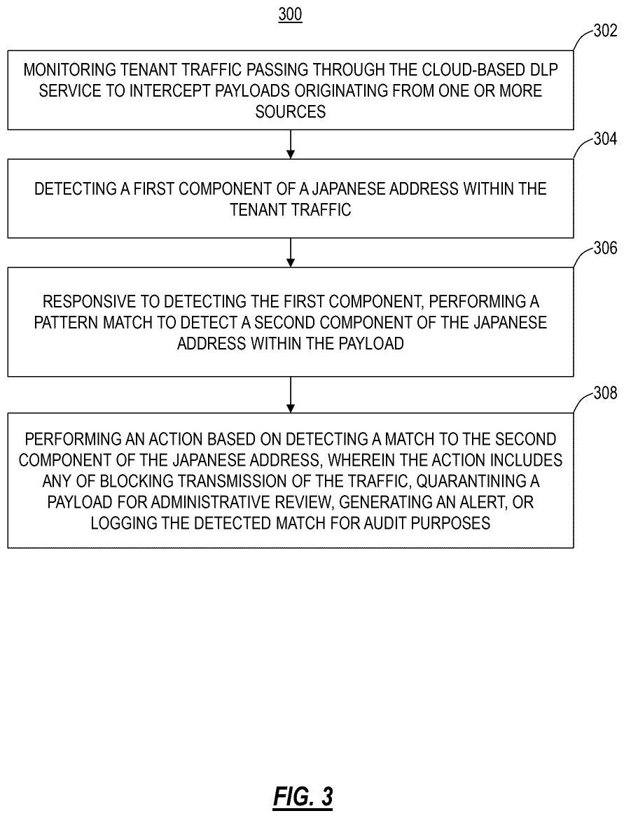

FIG. 3 is a flowchart of a process 300 for detecting Japanese addresses within network traffic via a cloud-based Data Loss Prevention (DLP) service. In various embodiments, the process 300 can be implemented in multiple ways: as a method comprising distinct steps, via the computing system 100 configured to execute those steps, via a cloud system configured to do so, or through a non-transitory computer-readable medium that stores instructions causing one or more processors to perform the steps. This flexibility allows process 300 to be adapted to various system architectures and deployment scenarios.

The process 300 includes monitoring tenant traffic passing through the cloud-based DLP service to intercept payloads originating from one or more sources (step 302); detecting a first component of a Japanese address within the tenant traffic (step 304); responsive to detecting the first component, performing a pattern match to detect a second component of the Japanese address within the payload (step 306); and performing an action based on detecting a match to the second component of the Japanese address, wherein the action includes any of blocking transmission of the traffic, quarantining a payload for administrative review, generating an alert, or logging the detected match for audit purposes (step 308).

The process 300 can further include wherein the first component of the Japanese address includes a combination of a prefecture and a city. The first component of the Japanese address can be detected using a hyperscan engine, the hyperscan engine performing high-speed scanning of tenant traffic against a precompiled database of potential prefecture and city combinations. The precompiled database of prefecture and city combinations can include standard combinations of Japanese prefectures and primary cities or their linguistic representations in kanji, hiragana, katakana, or romaji. The pattern match for the second component of the Japanese address can be performed using Perl Compatible Regular Expressions (PCRE) starting from the end of the detected first component. The steps can further include consolidating the first component and second component matches into a composite match trigger that captures the entire Japanese address from the beginning of the first component to the end of the second component. The steps can further include monitoring traffic dynamically in real time, such that matches are detected and actions are performed with minimal latency or disruption to tenant operations. The first component detection and second component detection can be stored as part of metadata records within the cloud-based DLP service for post-incident analysis. The steps can further include applying machine learning models to improve detection accuracy by analyzing context surrounding the detected first component and second component within payloads. The tenant traffic can include structured data, unstructured data, or multimedia files containing embedded Japanese address information.

### Conclusion

In this disclosure, including the claims, the phrases “at least one of” or “one or more of” when referring to a list of items mean any combination of those items, including any single item. For example, the expressions “at least one of A, B, or C,” “at least one of A, B, and C,” “one or more of A, B, or C,” and “one or more of A, B, and C” cover the possibilities of: only A, only B, only C, a combination of A and B, A and C, B and C, and the combination of A, B, and C. This can include more or fewer elements than just A, B, and C. Additionally, the terms “comprise,” “comprises,” “comprising,” “include,” “includes,” and “including” are intended to be open-ended and non-limiting. These terms specify essential elements or steps but do not exclude additional elements or steps, even when a claim or series of claims includes more than one of these terms.

Although operations, steps, instructions, blocks, and similar elements (collectively referred to as “steps”) are shown or described in the drawings, descriptions, and claims in a specific order, this does not imply they must be performed in that sequence unless explicitly stated. It also does not imply that all depicted operations are necessary to achieve desirable results. In the drawings, descriptions, and claims, extra steps can occur before, after, simultaneously with, or between any of the illustrated, described, or claimed steps. Multitasking, parallel processing, and other types of concurrent processing are also contemplated. Furthermore, the separation of system components or steps described should not be interpreted as mandatory for all implementations; also, components, steps, elements, etc. can be integrated into a single implementation or distributed across multiple implementations.

While this disclosure has been detailed and illustrated through specific embodiments and examples, it should be understood by those skilled in the art that numerous variations and modifications can perform equivalent functions or achieve comparable results. Such alternative embodiments and variations, even if not explicitly mentioned but that achieve the objectives and adhere to the principles disclosed herein, fall within the spirit and scope of this disclosure. Accordingly, they are envisioned and encompassed by this disclosure and are intended to be protected under the associated claims. In other words, the present disclosure anticipates combinations and permutations of the described elements, operations, steps, methods, processes, algorithms, functions, techniques, modules, circuits, and so on, in any conceivable order or manner—whether collectively, in subsets, or individually—thereby broadening the range of potential embodiments.

What is claimed is:

1. A method for detecting Japanese addresses within network traffic via a cloud-based Data Loss Prevention (DLP) service, the method comprising steps of:
monitoring tenant traffic passing through the cloud-based DLP service to intercept payloads originating from one or more sources;
detecting a first component of a Japanese address within the tenant traffic;
responsive to detecting the first component, performing a pattern match to detect a second component of the Japanese address within the payload; and
performing an action based on detecting a match to the second component of the Japanese address, wherein the action includes any of blocking transmission of the traffic, quarantining a payload for administrative review, generating an alert, or logging the detected match for audit purposes.

2. The method of claim 1, wherein the first component of the Japanese address includes a combination of a prefecture and a city.

3. The method of claim 2, wherein the first component of the Japanese address is detected using a hyperscan engine, the hyperscan engine performing high-speed scanning of tenant traffic against a precompiled database of potential prefecture and city combinations.

4. The method of claim 3, wherein the precompiled database of prefecture and city combinations includes standard combinations of Japanese prefectures and primary cities or their linguistic representations in kanji, hiragana, katakana, or romaji.

5. The method of claim 1, wherein the pattern match for the second component of the Japanese address is performed using Perl Compatible Regular Expressions (PCRE) starting from an end of the detected first component.

6. The method of claim 1, further comprising consolidating the first component and second component matches into a composite match trigger that captures the Japanese address from a beginning of the first component to an end of the second component.

7. The method of claim 1, further comprising monitoring traffic dynamically in real time, such that matches are detected and actions are performed with minimal latency or disruption to tenant operations.

8. The method of claim 1, wherein the first component detection and second component detection are stored as part of metadata records within the cloud-based DLP service for post-incident analysis.

9. The method of claim 1, further comprising applying machine learning models to improve detection accuracy by analyzing context surrounding the detected first component and second component within payloads.

10. The method of claim 1, wherein the tenant traffic comprises structured data, unstructured data, or multimedia files containing embedded Japanese address information.

11. A non-transitory computer-readable medium comprising instructions for detecting Japanese addresses within network traffic via a cloud-based Data Loss Prevention (DLP) service that, when executed, cause one or more processors to perform steps of:
monitoring tenant traffic passing through the cloud-based DLP service to intercept payloads originating from one or more sources;
detecting a first component of a Japanese address within the tenant traffic;
responsive to detecting the first component, performing a pattern match to detect a second component of the Japanese address within the payload; and
performing an action based on detecting a match to the second component of the Japanese address, wherein the action includes any of blocking transmission of the traffic, quarantining a payload for administrative review, generating an alert, or logging the detected match for audit purposes.

12. The non-transitory computer-readable medium of claim 11, wherein the first component of the Japanese address includes a combination of a prefecture and a city.

13. The non-transitory computer-readable medium of claim 12, wherein the first component of the Japanese address is detected using a hyperscan engine, the hyperscan engine performing high-speed scanning of tenant traffic against a precompiled database of potential prefecture and city combinations.

14. The non-transitory computer-readable medium of claim 13, wherein the precompiled database of prefecture and city combinations includes standard combinations of Japanese prefectures and primary cities or their linguistic representations in kanji, hiragana, katakana, or romaji.

15. The non-transitory computer-readable medium of claim 11, wherein the pattern match for the second component of the Japanese address is performed using Perl Compatible Regular Expressions (PCRE) starting from an end of the detected first component.

16. The non-transitory computer-readable medium of claim 11, further comprising consolidating the first component and second component matches into a composite match trigger that captures the Japanese address from a beginning of the first component to an end of the second component.

17. The non-transitory computer-readable medium of claim 11, further comprising monitoring traffic dynamically in real time, such that matches are detected and actions are performed with minimal latency or disruption to tenant operations.

18. The non-transitory computer-readable medium of claim 11, wherein the first component detection and second component detection are stored as part of metadata records within the cloud-based DLP service for post-incident analysis.

19. The non-transitory computer-readable medium of claim 11, further comprising applying machine learning models to improve detection accuracy by analyzing context surrounding the detected first component and second component within payloads.

20. The non-transitory computer-readable medium of claim 11, wherein the tenant traffic comprises structured data, unstructured data, or multimedia files containing embedded Japanese address information.
